(19) United States
(12) Patent Application Publication
(10) Pub. No.: US 2005/0083534 A1
(43) Pub. Date: Apr. 21, 2005

(54) Agile high sensitivity optical sensor

(76) Inventors: Nabeel Agha Riza, Oviedo, FL (US); Frank Perez, Tujunga, CA (US)

Correspondence Address: BEUSSE BROWNLEE WOLTER MORA & MAIRE, P. A., 390 NORTH ORANGE AVENUE, SUITE 2500, ORLANDO, FL, 32801, US

(21) Appl. No.: 10/928,601

(22) Filed: Aug. 27, 2004

Related U.S. Application Data
(60) Provisional application No. 60/498,558, filed on Aug. 28, 2003.

(51) Int. Cl. G01B 9/02

(52) U.S. Cl. 356/477

(57) ABSTRACT

An agile optical sensor based on scanning optical interferometry is proposed. The preferred embodiment uses a retroreflective sensing design while another embodiment uses a transmissive sensing design. The basic invention uses wavelength tuning to enable an optical scanning beam and a wavelength dispersive element like a grating to act as a beam splitter and beam combiner to create the two beams required for interferometry. A compact and environmentally robust version of the sensor is an all-fiber in-line low noise delivery design using a fiber circulator, optical fiber, and fiber lens connected to a Grating-optic and reflective sensor chip.

### SPECIFIC DATA RELATED TO THE INVENTION

This application claims the benefit of U.S. Provisional Application No. 60/498,558 filed on Aug. 28, 2003.

### BACKGROUND OF THE INVENTION

Scanning optical interferometry is the field of invention. It is well known that optical interferometry can be used to detect very small changes in optical properties of a material (e.g., refractive index, material thickness). These changes can be man-made such as on a phase-encoded optical security card or environmentally induced such as by temperature changes in a jet engine.

Earlier, for example, acousto-optic devices or Bragg cells have been used to form scanning interferometers such as in N. A. Riza, “Scanning heterodyne acousto-optical interferometers,” U.S. Pat. No. 5,694,216, Dec. 2, 1997; N. A. Riza, “In-Line Acousto-Optic Architectures for Holographic Interferometry and Sensing,” OSA Topical Meeting on Holography Digest, pp. 13-16, Boston, May, 1996; N. A. Riza, “Scanning heterodyne optical interferometers,” Review of Scientific Instruments, American Institute of Physics Journal, Vol. 67, pp. 2466-2476 7 Jul. 1996; and N. A. Riza and Muzamil A. Arain, “Angstrom-range optical path-length measurement with a high-speed scanning heterodyne optical interferometer,” Applied Optics, OT, Vo. 42, No. 13, pp. 2341-2345, 1 May 2003. These interferometers use the changing RF (radio frequency) of the Bragg cell drive to cause a one dimensional (1-D) scanning beam. The limitations of this design include the temperature dependence, bulky size, high drive power requirements of the Bragg cell, limiting this scanning interferometer's use for optical sensing in hostile remote settings. Moreover, these are not passive optical sensors, i.e., they require electrical power delivery at the sensor front end (in this case, RF power to the Bragg cell) for sensor operations. This power delivery means requiring extra remote cabling to the sensor, adding to the bulk and complexity of the sensor frontend that engages the sensing zone.

Hence, the goal of this invention is to form a robust ultra-compact passive frontend interferometric optical sensor with remoting and optical beam scan capabilities so as to act as a remote time multiplexed sampling head.

### SUMMARY OF THE INVENTION

An agile optical sensor based on scanning optical interferometry in one embodiment uses a retroreflective sensing design while another embodiment uses a transmissive sensing design. The basic invention uses wavelength tuning to enable an optical scanning beam and a wavelength dispersive element like a grating to act as a beam splitter and beam combiner to create the two beams required for interferometry. A compact version of the sensor is an all-fiber delivery design using a fiber circulator, optical fiber, and fiber lens connected to a Grating-optic and reflective sensor chip. An all-fiber design is also possible using a transmissive sensor chip and two fiber segments with related Grating-optics and fiber lens optics. Freespace optic designs are also possible for this sensor using bulk-optics. Another embodiment of the sensor using two fibers in the remoting cable includes a two receive-channel interferometric optical sensor design for lower noise sensing with improved signal processing. The sensor chip can be any optically sensitive material that changes optical properties due to effects such as temperature, pressure, material composition, and electronic states. Applications for the proposed invention include industrial sensing, security systems, optical and material characterizations, biological sensing, ultrasonic sensing, RF/antenna field sensing. It is also possible to not use a sensor chip, but to directly engage the sensing zone (e.g., human tissue) via the freespace beam used for capturing the sensing signature while the other beam (not entering the sensing zone) is used as a reference beam. Another option can include differential sensing where both beams are present in the sensing zone (e.g., tissue).

### BRIEF DESCRIPTION OF THE DRAWINGS

FIG. 1 illustrates one embodiment of a single remote fiber, all-passive frontend, optical scanning, reflective sensing mode interferometric sensor;

FIG. 2 illustrates an embodiment of the internal design of the scan front-end of a z-scan interferometric sensor;

FIG. 3 illustrates an embodiment of a starring-mode single remote fiber. passive front-end, optical interferometric sensor that allows simultaneous sensing of different spatial points in the reflective sensing zone;

FIG. 4 illustrates an embodiment of a dual remote fiber, all-passive frontend, optical scanning, transmissive sensing mode interferometric sensor; and

FIG. 5 illustrates an embodiment of a multi-fiber, all-passive frontend, optical scanning, reflective sensing mode interferometric sensor with dual-signal pair receive signals for low noise signal processing.

### DETAILED DESCRIPTION OF THE INVENTION

It is well known that changes of wavelength coupled with a wavelength dispersive optic can lead to one-dimensional (“1-D”) beam scans in freespace. This idea dates back to the 1970s, and has been explored to make optical scanners, optical radar, optical microscopy, optical printing, and optical memory system for holographic data recording. More recently, this wavelength tuning along with wavelength selection has been proposed for wide coverage optical laser scanners and optical data reading devices. In addition, wavelength tuning combined with traditional fiber-optics such as 2×2 couplers have been used to form interferometers. All these works are described in the following references: R. L. Forward, U.S. Pat. No. 3,612,659, Oct. 12, 1971; R. S. Hughes, et.al., U.S. Pat. No. 4,184,767, Jan. 22, 1980; K. G. Leib, U.S. Pat. No. 4,250,465, Feb. 10, 1981; K. G. Leib, U.S. Pat. No. 4,735,486, Apr. 5, 1988; T. Inagaki, U.S. Pat. No. 4,938,550, Jul. 3, 1990; B. Picard, U.S. Pat. No. 4,965,441, Oct. 23, 1990; G. Li, P. C. Sun, P. C. Lin, Y. Fainman, Optics Letters, Vol. 25, pp. 1505-1507, 2000; J. R. Andrews, U.S. Pat. No. 5,204,694, Apr. 20, 1993; N. A. Riza, “Photonically controlled ultrasonic probes,” U.S. Pat. No. 5,718,226, Feb. 17, 1998; N. A. Riza, “Photonically controlled ultrasonic arrays: Scenarios and systems,” IEEE Ultrasonic Symposium, Vol. 2, pp. 1545-1550, November 1996; N. A. Riza, “Wavelength Switched Fiber-Optically Controlled Ultrasonic Intracavity Probes,” IEEE LEOS Ann. Mtg. Digest, pp. 31-36, Boston, 1996; G. J. Tearney, R. H. Webb, and B. E. Bouma, “Spectrally encoded confocal microscopy,” Optics Letters, Vol. 23, No. 15, pp. 1152-1154, August 1998; G. J. Tearney, et.al., U.S. Pat. No. 6,134,003, Oct. 17, 2000; N. A. Riza and Y. Huang, “High speed optical scanner for multi-dimensional beam pointing and acquisition,” IEEE-LEOS Annual Meeting, San Francisco, Calif., pp. 184-185, November 1999; N. A. Riza and Z. Yaqoob, “High Speed Fiber-optic Probe for Dynamic Blood Analysis Measurements,” EBIOS 2000: EOS/SPIE European Biomedical Optics Week, SPIE Proc. vol. 4613, Amsterdam, July 2000; N. A. Riza, “Multiplexed optical scanner technology (MOST),” IEEE LEOS Annual Meeting, paper ThP5, Pueto Rico, USA, Nov. 12, 2000; N. A. Riza and Z. Yaqoob, “Ultra-high speed scanner for data handling,” IEEE LEOS Annual Meeting, paper ThP2, Pueto Rico, USA, Nov. 12, 2000; Z. Yaqoob and N. A. Riza, “High-speed scanning probes for internal and external cavity biomedical optics,” OSA Biomedical Topical Meetings, pp. 381-383, Miami, Fla., USA, Apr. 7-10 2002; Z. Yaqoob and N. A. Riza, “Free-Space Wavelength-Multiplexed Optical Scanner Demonstration,” Applied Optics-IP, Vol. 41, Issue 26, Page 5568 (September 2002; Z. Yaqoob and N. A. Riza, “Low-loss wavelength-multiplexed optical scanner for broadband transmit-receive lasercom systems using volume Bragg gratings,” SPIE Conference on Free-Space Laser Communication and Active Laser Illumination III, SPIE Proc. Vol. 5160, No. 47, 6 Aug. 2003, San Diego, Calif. USA.

It has been proposed that an interferometric optical sensor with a no-moving parts scanning arm can be formed using a traditional Michelson interferometer design with a 2×2 fiber-optic coupler component and physically separated fiber arms. In effect, one fiber arm contains a wavelength tuned freespace optical scanner based on a Grating optic and another completely separate fiber arm forms a reference arm with a mirror. Although this design forms an interferometric sensor, the design uses many components and separate fiber arms, making it less robust to noise such as from fiber stresses and strains and other component vibrations such as vibration of the Grating optic in the scanning arm. Moreover, the fiber-optics is not ultra-compact to form a single remote sensing head and so cannot be deployed where space is premium.

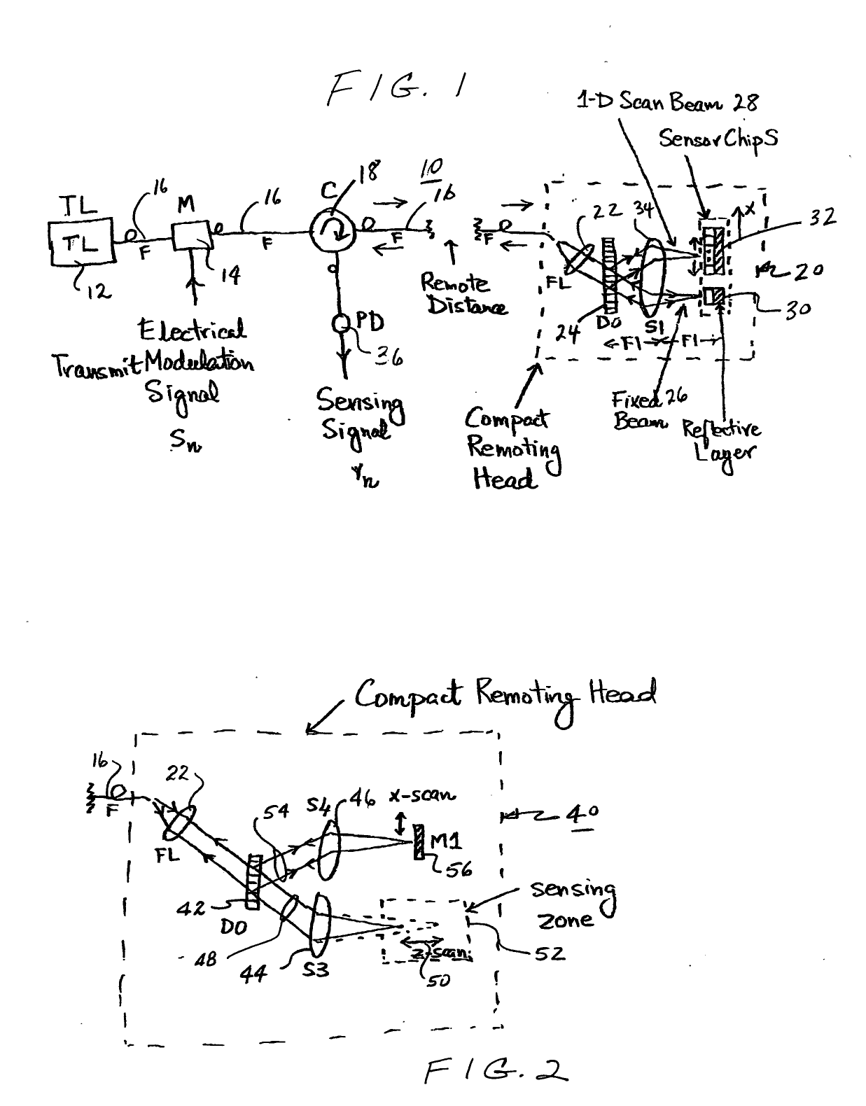

FIG. 1 is a simplified representation of one design 10 according to the present invention of a noise tolerant, single remote fiber, all-passive frontend, optical scanning interferometric sensor. Light from a tunable laser (TL)12 is (if required) electrically modulated in phase/frequency/amplitude via an electrical-to-optical modulator 14 in response to a modulation signal Sₙ, where n is the nth wavelength transmit modulation. A single mode fiber 16 couples light between the elements of FIG. 1. One segment of fiber 16 couples light from modulator 14 to a 3-port fiber-optic circulator 18 that directs the light via another fiber 16 segment to the compact remote head optics 20. Light from fiber 16 is collimated by a tiny fiber lens 22 and then incident at the required (e.g. Bragg) angle of a highly dispersive optic device 24, such as a diffraction Grating, photonic crystal superprism, or any other in-line wavelength dispersive 1:2 beam splitting single optic. For example, optic device 24 can be a holographic grating such as a thin grating with a wide spectral response with high diffraction efficiency (e.g., 90%) for the first diffracted order. Specifically, the ultra-compact optic device 24 acts as a tiny beam splitter creating the un-deflected or stationary beam 26 and the +1 order or deflected scan beam 28. The two beams 26, 28 are directed onto optical sensors 30, 32, respectively, by a focusing lens 34 having a focal length F1. The ratio of optical power between the two beams 26, 28 depends on the diffractive optic device 24 and can be tailored to match requirements of sensors 30, 32. Similarly, the polarization properties of the device 24 can be designed to match sensor needs. For instance, the Dickson grating is well known for its low (<0.2 dB) polarization dependence and hence works well with regular single mode fibers. The device 24 must also simultaneously act as a wavelength dispersive element so a wavelength encoded scan beam can be generated. Hence the device 24 is a beam splitter/beam combiner plus a dispersive prism effect component. It turns out that a grating such as the holographic phase grating makes an excellent dispersive optical device 24, and is preferred in this application.

When the laser wavelength is changed or tuned, the scan beam 28 moves along in one-dimension on the sensor chip 32 while the fixed reference beam 26 stays fixed on the reference position of sensor chip 30. The sensor chips 30, 32 are designed to be reflective in nature, so light reflected from both the stationary beam 26 and the scan beam 28 trace back their paths to enter the fiber 16 again. Hence, now two optical beams as required for interferometric sensing travel back the fiber path 16 and exit the circulator 18 to be detected by a photodetector 36. Based on the relative phase and amplitude of the two received beams, photodetector 36 will produce a sensing signal corresponding to the sensing parameters present at the remote sensor chip. Note that the lens 34 with focal length F1 acts to create a one-dimension point scan region on the sensor chip 32. Note that because an in-line, self-aligning design is formed after the fiber 16 tip in the remote head 20, all of the light suffers similar noise effects until it reaches the sensor chips 30, 32. In addition, both beams 26, 28 share the same fiber cable 16 and hence the same stresses and strains. Hence, both beams carry correlated noise that later cancels out on interferometric detection, providing a low noise compact remote head design. Intelligent RF modulation of the laser 12 can be deployed to add enhanced signal processing features to the sensor head 20. Note that all the remote head optics can be extremely small in size (e.g., 1 mm diameter), hence making an ultra-compact sensor head 20.

There are numerous options for the sensor chips 30, 32 that is reflective in nature. Sensor chip 32 can be a reflection layer coated silicon carbide (SiC) sensor chip whose refractive index varies with temperature change. The fixed beam 26 can strike a fixed reflectivity mirror surface on chip 30, while the scan beam 28 can strike physically separate reflection channels with temperature sensitive filled materials on chip 32. For a given nth laser wavelength, a given nth sensor chip reflection channel can be accessed. Thus, the fixed beam 26 provides a fixed optical phase and amplitude reference while the scan beam 28 spatially samples the changing (e.g., temperature) scenario of the sensed zone. Since tunable lasers can tune at nanosecond speeds, very fast interferometric spatial sampling along a one-dimensional spatial direction can be implemented with the sensor system of FIG. 1. Temporal effects in the sensing zone of head 20 can be captured (such as Doppler flow information) using this sensor system.

The principles incorporated in the system of FIG. 1 can also be applied to sensing parameters other than temperature, such as, for example, pressure or material composition. In effect, the proposed interferometric scanning sensor 10 can be applied across any sensing zone or sensor chip mechanism as there are always two beams available—one that can act as the sensing beam and the other that can act as a given amplitude and phase reference beam. Thus, the design of FIG. 1 provides an ultra-compact fiber-remoted interferometric sensor.

An application where the sensor head 20 can have a fixed setup is an optical security card code chip that is inserted into the scan zone of the sensor beam 28 to be read. In this or other applications, the roles of the scan and fixed beams can be reversed. For example, the fixed beam can interrogate a sensing point/zone while the scanned beam can access different reference sites to implement a comparative sensing operation. In this approach, the same fixed point is exposed to all the laser wavelengths, one wavelength at a time by tuning the source 12, allowing broadband sensing data to be generated. In another form, one of the two beams at the sensing head 20 can also be temporally modulated such as via a vibrating piston-type moving mirror (not shown) to induce a phase modulation frequency or via a shutter-type spatial light modulator (SLM), (not shown) that acts as a phase or amplitude modulator. Hence, by introducing modulation into one of the beams, heterodyne detection at the desired intermediate modulation frequency can be achieved, providing low 1/frequency noise sensor detection.

Polarization effects that may be caused by polarization dependent diffraction effects of the optical device 24, such as a holographic grating, can be reduced by positioning a 45 degree power Faraday rotator between the lens 34 and the reflective sensors 30, 32 to reduce polarization dependent effects in the overall sensor.

While the sensor head 20 uses a device 24 that is shown as a single transmissive grating such as a holographic grating, any other type of grating such as a reflection Blazed grating made using diffractive optics technology can be used for the device 24 with appropriate alignment of the sensor beams. The device 24 design sets the diffraction efficiency and relative angles between the fixed and diffracted/deflected beams 26, 28. Although FIG. 1 discloses a system to scan the diffracted beam in one dimension, it is also possible to scan the beam 28 in three dimensions. For instance, the device 24 can be a holographic device with multiple wavelength-coded gratings stored as holograms in different x-y planes in the holographic device. By tuning the laser light source 12, each Bragg wavelength matches to a given x-y plane grating and hence produces a given x-y diffracted beam deflection in two dimensions. One hologram with multiple tilted gratings or stacked plates each with tilted gratings can cause the wavelength tuned diffracted beam to steer in two dimensions. See, for example, U.S. Pat. No. 3,612,659 and article by Z. Yaqoob, M. Arain, N. A. Riza, “Wavelength Multiplexed Optical Scanner Using Photothermorefractive Glasses, Applied Optics, September 2003. Applying this two-dimensional (2-D) wavelength tuned scanning using multiple gratings to FIG. 1 creates an interferometric optical sensor that can produce a 2-D scanning beam. The reference or stationary beam 26 is also produced and used with the 2-D optic device to produce a powerful 2-D scanning interferometric sensor using wavelength tuning in an ultra-compact fashion.

In U.S. Pat. No. 4,965,441, it was suggested that wavelength coding of light coupled with a high chromatic dispersion lens can result in a beam with wavelength coded focal planes. In effect, wavelength tuning of light can cause beam scanning of light along the optic-axis or z-direction. FIG. 2 shows a modification of the interferometric optical sensor head 20 of FIG. 1 that can utilize the wavelength-coded depth scanning mechanism to realize a z-scan interferometric sensor head 40. Sensor head 40 comprises a fiber lens 22, a single optical separation device 42, such as a Dickson grating, and two lenses 44 and 46. Lens 44 is a high chromatic dispersion lens whose focal length changes with wavelength. Lens 46 is a classic achromatic lens design to have minimal focal length change with wavelength. The reference or undiffracted beam 48 from the optical device 42 passes through lens 44 and hence does not scan in a direction parallel to device 42 (indicated as the “x-direction”) when wavelength is changed. However, the beam 48 scans along a z-axis (optical axis) 50 as the wavelength is tuned producing focused points along the sensing z-axis of a sensing zone 52. The diffracted and deflected beam 54 passes through lens 46 and generates an x-scanning beam on a reference mirror 56. As the laser tunes, i.e., changes frequency, the path length on the reference mirror 56 stays fixed while the path length in the fixed x-y position but changing z-axis position changes as the beam scans in the z-direction 50. This path length change in the z-direction allows sensing data collection for different z-planes of the sensing zone 52. It is possible to temporally modulate the reference reflected beam 54 by phase-modulating the mirror via mirror piston motion at a desired modulation frequency. One can also use shutter-type amplitude modulation of the reflected reference beam 54 using a single pixel optical amplitude modulator, e.g., a liquid crystal modulator or a digital tilt-mirror modulator as the reference mirror. Hence, using modulation, one can implement heterodyne detection for the sensor head 40.

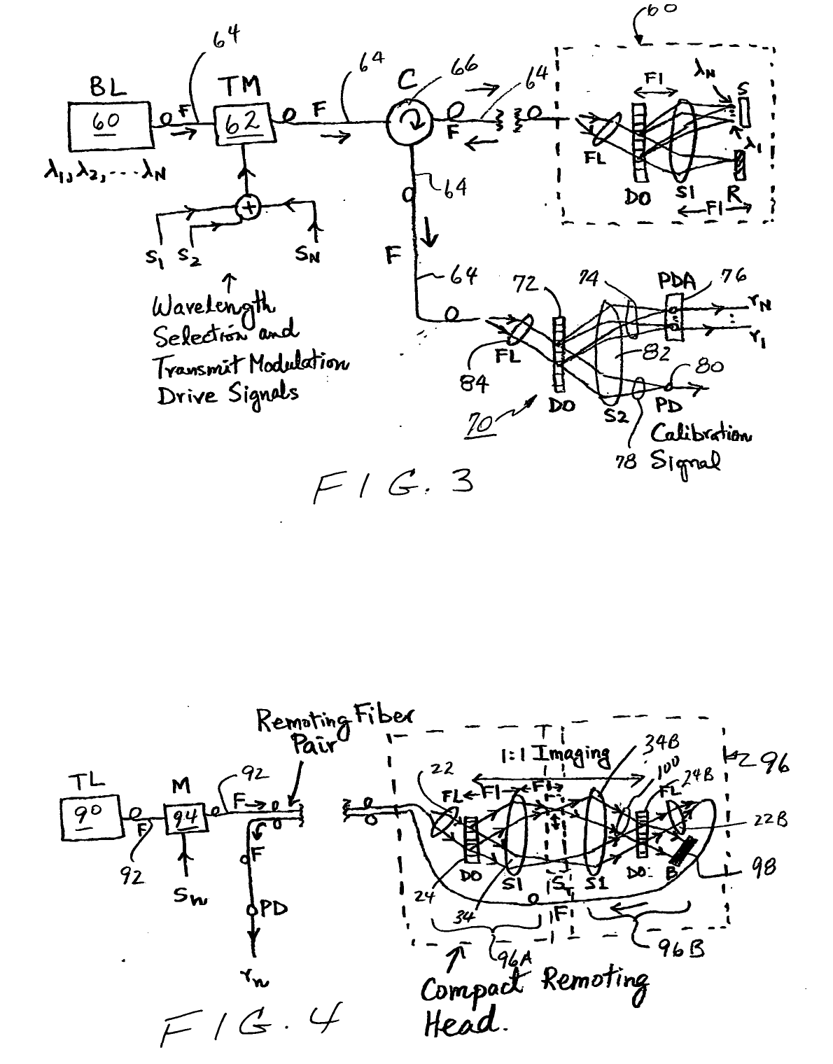

FIG. 3 illustrates an adaptation of the systems of FIGS. 1 and 2 into an interferometric sensor that can simultaneously provide interferometric sensing data for many spatial sensing channels. The tunable laser light source of FIG. 1 is replaced by a N-wavelength or broadband source 60. Modulation and channel/wavelength selection is achieved by controlling the drive signal set sₙ (n=1, 2, 3, . . . , N) to a tunable modulator device 62, such as an acousto-optic tunable filter (AOTF). All light coupling is via optical fiber indicated at 64. A circulator 66, similar to circulator 18 of FIG. 1, allows transmittal light to be passed through to sensor head 68 and reflected light to be passed to photodectector/receiver 70. Sensor head 68 may be either heads 20 or 40. Receiver 70 is similar to head 68 and uses another optical grating 72 to separate the N sensed optical beam pairs and directs the scanning beams 74 to respective individual photodetectors within an N photo-detector array chip 76. The non-diffracted light beam 78 strikes a single photodetector 80, and is used to calibrate the sensor 76 for power. A lens 82 focuses the beams 74, 78 onto the respective sensors. A collimating lens 84 directs light from fiber 64 to device 72.

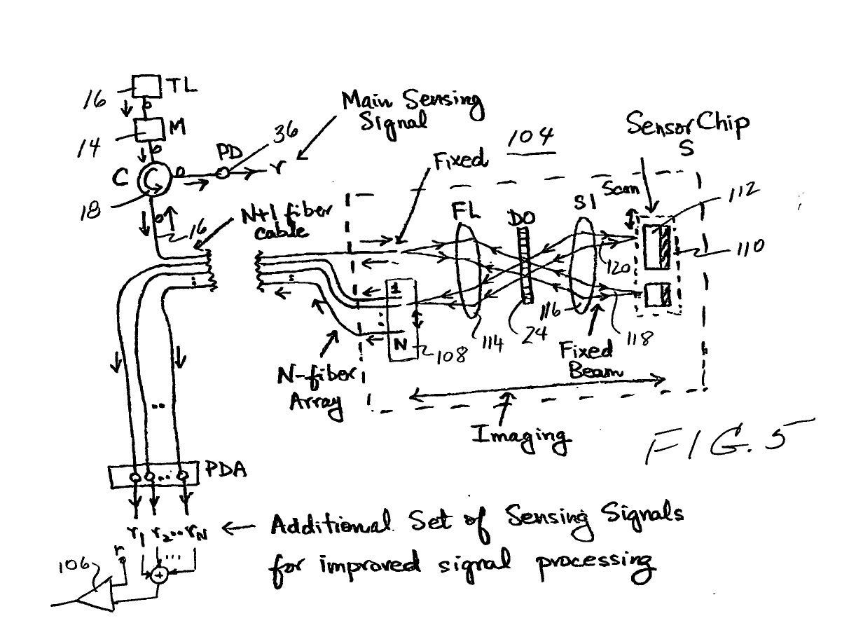

FIG. 4 illustrates an embodiment of the present invention adapted for a transmissive mode sensing device wherein the light passes through rather than being reflected from the device. The primary difference from FIG. 1 is the use of a pair of optical fibers or cables, one for delivering light to the sensors and one for carrying light from the sensors to a detector, with each fiber having its own set of lenses and refractors. A tunable laser 90 provides light via fiber 92 to a modulator 94, which modulator receives a transmit modulation signal from a conventional source (not shown). The modulated light is coupled from modulator 94 via fiber 92 to remote sensing head 96. Note that the circulator is not used since the light beam return path is through another optical fiber.

The sensor head 96 incorporates an optical receiving section 96A and an optical transmitting section 96B. Section 96A is substantially identical to the optical section of sensor head 20 of FIG. 1, i.e., each includes a collimating lens 22, a diffraction grating 24 and a focusing lens 34. The transmitting section 96B is essentially a mirror image of the receiving section but adds a light block 98 to absorb non-refracted light from transmitted beam 100. The remaining corresponding optical components use reference numbers from section 96A but with a B suffix. Sensor 96 is appropriate when transmissive sensing is desired in a sensing zone or with a predesigned sensor chip 102. The two lenses 34, 34B implement 1:1 imaging between the gratings 24, 24B. As the wavelength is tuned, the diffracted beam from the first grating 24 scans the sensing region of chip 102. The second grating 24B un-scans this diffracted beam via a second diffraction process, making the scanned beam and fixed or reference beams in-line so they can be fed into the fixed receive fiber 92B that sends light to the photodetector 36.

FIG. 5 shows an alternate embodiment of the invention using a multi-fiber optical scanning interferometric optical sensor system 104 with dual-channel per wavelength signal processing capabilities that can lead to low noise in-phase (I) and quadrature (Q) signal processing. Specifically, for each nth wavelength position (or scan beam position), the sensor system 104 generates the standard in-phase sensing signal “r” via the circulator 18 and detector 36. In addition, sensor system 104 also generates an nth sensing signal rₙ (n=1, 2, . . . N) for the nth wavelength that is quadrature with the standard sensed signal “r”. Thus, for each sensor scan position on chip 32, a pair of output electrical signals (an “r” and an “rₙ”) are generated that can be used for differential detection via an operational amplifier 106 for signal noise cancellation and improved signal-to-noise ratios for the sensor. The operation of the FIG. 5 system requires the diffracting optical device 24 (e.g. grating) to operate in a spatially symmetric way. Imaging is implemented between the sensor head N+1 fiber array 108 and the sensing zone 110 where the sensor chip 112 may be placed. The focal lengths of lenses 114 and 116 can be chosen such that appropriate compact design is implemented. Light enters via the path of tunable laser 12, modulator 14, circulator 18, fiber 16 to be collimated by lens 114 to strike the diffracting device 24 (e.g., grating optic), generating a fixed reference beam 118 and a diffracted/deflected scan beam 120. On retroreflection from the sensing zone 110, both reference and diffracted beams return to the device 24 where both beams undergo another diffraction. Hence, two reflected beam pairs exit the device 24, one collinear beam pair goes back through the original input fiber 16 and hence is a stationary beam pair regardless of wavelength. This beam pair travels via the fiber 16 to the circulator 18 and is then directed to the photodetector 36 to generate the standard in-phase sensing signal “r”. The diffracting optical device 24 also generates another beam pair from the retroreflection double diffraction process. This beam pair is also collinear but moves along a one-dimension direction on the N-fiber array 108 depending on the laser wavelength. Hence, for the nth-wavelength setting, this particular collinear beam pair enters the nth-fiber in the N-fiber array, traveling via the fiber to the nth photodetector on an N-element photodetector array 120. The nth photodetector in the array 120 generates the quadrature electrical signal rₙ for the nth-wavelength setting. Thus, for any given wavelength, a pair of sensing receive signals “r” and “rₙ” are generated that can be then fed to the differential amplifier 106 for low noise sensing signal generation. In effect, the FIG. 5 system uses the device 24 optic (e.g., planar grating optic) as a 2×2 coupler. The system of FIG. 5 can be enabled for two dimension and three dimension scanning by modification in accordance with the system of FIG. 2.

1. A remote sensing system comprising:
a sensor device having optical characteristics that vary in response to changes in a monitored condition;
a tunable laser light source;
an optical diffraction device coupled to receive light from the light source;
a focusing lens positioned for directing light passing through the diffractive device onto the sensor device and for directing reflected light from the sensor device back through the diffraction device; and
a photodetector arranged for receiving the reflected light and for providing sensing signals responsive thereto.

2. The remote sensing system of claim 1 and including an optical fiber for coupling light from the light source to the diffraction device.

3. The remote sensing system of claim 2 and including a collimating lens at an end of the optical fiber for directing light onto the diffraction device.

4. The remote sensing system of claim 3 and including a modulator connected in the optical fiber for modulation of the light from the light source.

5. The remote sensing system of claim 4 and including a circulator connected in the optical fiber between the modulator and diffraction device, the circulator redirecting reflected light from the sensor device onto the photodetector.

6. The remote sensing system of claim 5 and including a reflective device positioned adjacent the diffraction device for reflecting non-diffracted light back through the diffraction device and to the photodetector.

7. The remote sensing system of claim 6 wherein the focusing lens comprises a first high chromatic dispersion lens and a second low chromatic dispersion lens, the first lens effecting a Z-axis scan with changing wavelength of light from the light source.

8. The remote sensing system of claim 6 wherein the photodetector comprises:
an optical difffractor;
a collimating lens for directing reflected light onto the optical diffractor;
a Fourier lens positioned for receiving diffracted and non-diffracted light passing through the optical diffractor;
a first plurality of photodetectors positioned to receive diffracted light from said Fourier lens, each of the photodetectors of the plurality of photodetectors being oriented to respond to a different wavelength of light by producing a corresponding detection signal; and
a second photodetector positioned to receive non-diffracted light from the diffractor for providing a calibration signal.
